(19) United States
(12) Patent Application Publication
(10) Pub. No.: US 2014/0177729 A1
(43) Pub. Date: Jun. 26, 2014

(54) METHOD AND APPARATUS FOR TRANSCODING VIDEO DATA

(71) Applicant: ATI TECHNOLOGIES ULC, Markham (CA)

(72) Inventor: Haibo Liu, Scarborough (CA)

(73) Assignee: ATI TECHNOLOGIES ULC, Markham (CA)

(21) Appl. No.: 13/724,314

(22) Filed: Dec. 21, 2012

(51) Int. Cl. H04N 7/26

(52) U.S. Cl. CPC H04N 19/00472
USPC 375/240.24

(57) ABSTRACT

A method and apparatus for transcoding video data decodes video that is encoded in the first format and produces decoded data blocks that include decoded tile data such that each decoded block includes pixel data for multiple display lines. The method and apparatus performs a linear write operation on the decoded data block by controlling storing of the decoded data block rows in consecutive linear addresses in memory such that one line of memory comprises decoded data for multiple display lines from the same block. The method and apparatus fetches the line of memory and re-encodes the data into a data block format, In one example translation of the fetched line of memory back into the original decoded data block format is performed for re-encoding such that the block of data includes data for multiple display lines. The video data is re-encoded to the second format using the decoded data block that was translated from the fetched line of memory.

### FIELD OF THE DISCLOSURE

The disclosure relates generally to methods and apparatus for compressing and/or decompressing video information, and more particularly to methods and apparatus for transcoding video information.

### BACKGROUND OF THE DISCLOSURE

Video information typically requires high bandwidth and video is typically compressed prior to being stored or sent wirelessly. Transcoding is a process of decoding information from a compressed format/resolution/bit rate and re-encoding it into another compressed video format/resolution/bit rate. Transcoding can be employed, for example, where a network element such as a web server, or other device, encodes video in one format but the receiving device, such as a smart phone, only supports a lower bit rate compression algorithm such as according to the H.264 standard. For example, for video conferencing, the video may be initially encoded as an MJPEG but the receiving device may only display the information in an H.264 format. Accordingly, gateway elements such as servers or other transcoding apparatus decode the initially encoded video into decoded video. Once the video is decoded, it is then re-encoded using a different encoding format.

FIG. 1 diagrammatically illustrates decoded data blocks 100 and 102 that are produced by a decoder that decodes block oriented encoded video such as video encoded using MPEG encoding and other block based encoding techniques. By way of example, decoded data block 100 may be a 16×16 pixel block wherein each row 104 in the block corresponds to a portion of a display line on a display. Block data is also referred to as tile data since each block contains pixel information for multiple display lines. Known transcoding techniques store the decoded data blocks 100 and 102, in memory 106 by storing the same rows (lines) from differing decoded data blocks into a linear address space generally shown as memory address line 108 or they scatter the rows in differing memory locations using offsets. A block may include, for example, a 256 pixel block containing pixel data from 16 display lines and 16 columns of pixels. Sixteen bytes may make up one row of a block (assuming 8 bit pixel depth). Stated another way, the pixel data from multiple blocks is stored linearly in memory such that the first line of one block is followed by a first line from a second block and so on. However, since one block of data includes data for multiple display lines, and a decoder typically generates one block at a time, the linear mode memory packing technique needs to wait for multiple blocks that make up an entire line of a display. Also, given that the video data typically needs to be provided in high resolution and real time, large amounts of writing and reading to memory occurs. When a read operation is required to re-encode the data for transcoding, a block needs to be reconstructed in its entirety before re-encoding. A read may be a 64 byte read but each time only 16 bytes of data of the 64 byte read may be useful for a block's reconstruction so the memory bandwidth can be wasted on fetching data that is not needed for a display line.

Accordingly, there exists a need that overcomes one or more of the above drawbacks.

### BRIEF DESCRIPTION OF THE DRAWINGS

The embodiments will be more readily understood in view of the following description when accompanied by the below figures and wherein like reference numerals represent like elements, wherein:

FIG. 1 is a diagram illustrating one example of a linear storage format used as part of a decoding process as known in the art;

FIG. 2 is a block diagram illustrating one example of a system that employs a method and apparatus for transcoding video data in accordance with one embodiment in the disclosure;

FIG. 3 is a block diagram illustrating one example of a transcoder in accordance with one example set forth in the disclosure;

FIG. 4 is a diagram illustrating one example of storing decoded information as part of a transcoding process in accordance with one example set forth in the disclosure;

FIG. 5 is one example of a method for transcoding in accordance with one example set forth in the disclosure;

FIG. 6 is a flowchart illustrating one example of a method for transcoding video data in accordance with one example set forth in the disclosure;

FIG. 7 is a block diagram illustrating one example of a linear memory address tile data populator in accordance with one example set forth in the disclosure; and

FIG. 8 is a block diagram illustrating one example of a block data populator in accordance with one example set forth in the disclosure.

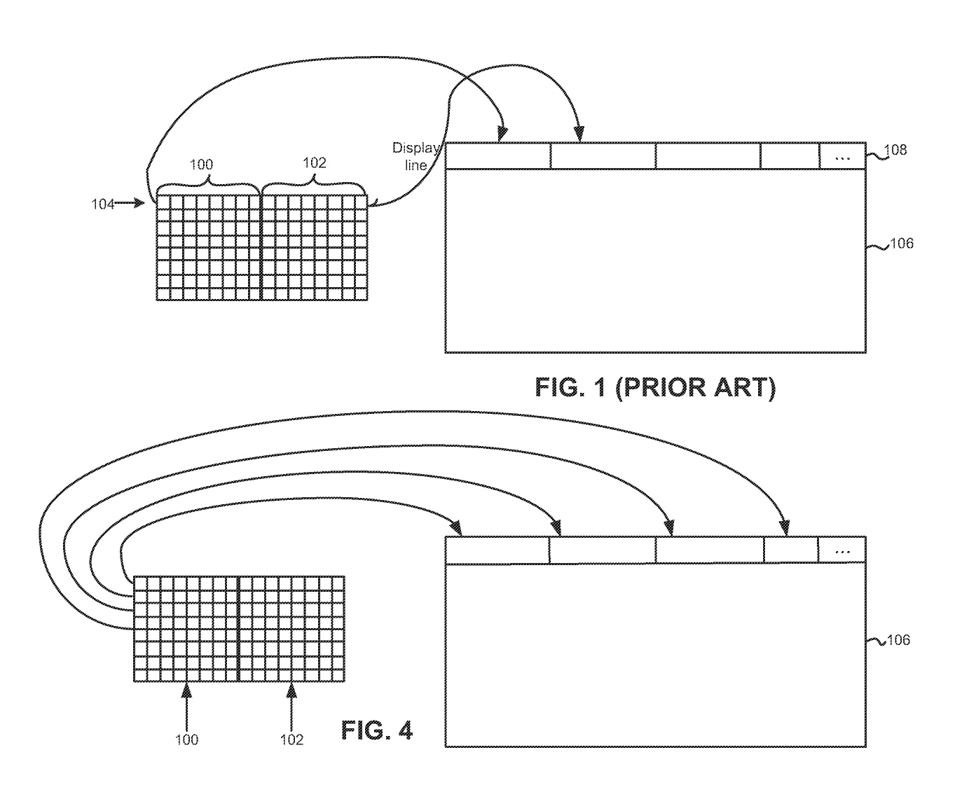

### DETAILED DESCRIPTION OF THE PREFERRED EMBODIMENTS

As set forth in certain embodiments below, a tile store operation is performed such that a pixel block is stored continuously as a linear line store operation so that line fetching can occur for the block based re-encoding operation. Certain embodiments provide for a method and apparatus that populates a linear line store of memory with tile data from one data block that contains information for multiple display lines and performs a line fetch operation to retrieve data for re-encoding. The line fetched data may be reformatted into block data for reencoding. Among other advantages, the encoder for re-encoding will obtain the uncompressed data in the same tiled format but based on linear memory addresses reads such that the data is more localized and less transactions are required to retrieve the data thereby improving memory use bandwidth.

In one disclosed example, a method and apparatus for transcoding video data decodes video that is encoded in the first format and produces decoded data blocks that include decoded tile data such that each decoded block includes pixel data for multiple display lines. The method and apparatus performs a linear write operation on the decoded data block by controlling storing of the decoded data block rows in consecutive linear addresses in memory such that one line of memory comprises decoded data for multiple display lines from the same block. The method and apparatus fetches the line of memory and translates the line of memory back into the original decoded data block format for re-encoding such that the block of data includes data for multiple display lines. The method and apparatus re-encodes the video data to the second format using the decoded data block that was translated from the fetched line of memory.

In one example, a decoder writes out uncompressed data in a tiled format into memory and an encoder is used to re-encode the uncompressed data in a tile format by reading the uncompressed data in the same tiled format using memory line fetches. This can greatly reduce the memory read bandwidth requirement compared with prior systems. In one example, uncompressed data output from a decoder is stored in a 16×16 tiled format for luma data and in an 8×8 tiled format for chroma data assuming a 4:2:0 chroma subsampling. As such, a method and apparatus stores data the way the decoder decodes the data instead of in a way that a user typically sees the data on a display. The method and apparatus may be employed in any suitable device such as a media gateway, within wireless user equipment such as a smart phone, as part of a video teleconferencing system, or in any other suitable device or system that employs transcoding. Transcoding may be used where different video data compression formats are employed so that different codecs or devices using different compression standards or ratios may provide compressed data for each other or within the device itself.

In one example, a system is disclosed where an apparatus for transcoding video data from a first format to a second format includes a video decoder that decodes video data that is encoded in the first format and produces at least one decoded data block wherein the decoded data block includes decoded data block for multiple display lines. A linear memory address data block populator performs a linear write operation on the decoded data block from the decoded data block by controlling storing of the decoded data block in consecutive linear addresses in memory. A line of memory includes decoded data for multiple display lines from the same block as opposed to data for a single display line from multiple blocks. For re-encoding, a data block populator performs memory line fetches and fetches the line of memory and translates the line of memory back into a decoded data block format (tile format) for re-encoding in a second format. Hence, the block of data includes data block for multiple display lines from a memory line fetch operation. An encoder then re-encodes the video data using the tile formatted data. In one example, the transmitter sends the re-encoded video in the second format to a display device. The display device may include a decoder that decodes the re-encoded video in the second format and displays the decoded video.

In one example, controlling the storing of the decoded data block in consecutive linear addresses in memory is performed by assigning sequential memory addresses to each byte of a decoded data block. In another example, a controller may be employed to determine whether a transcode mode has been selected. If the transcode mode has been selected, the controller causes the decoded data block to be stored in scattered memory addresses, such as non-sequential addresses or uses conventional tile write mode in memory. However, if the controller determines that transcoding is to be performed, then the controller selects the linear write mode so that one block is written as a line of memory. Accordingly, a tile write mode may be employed by the transcoder depending upon whether transcoding is to occur.

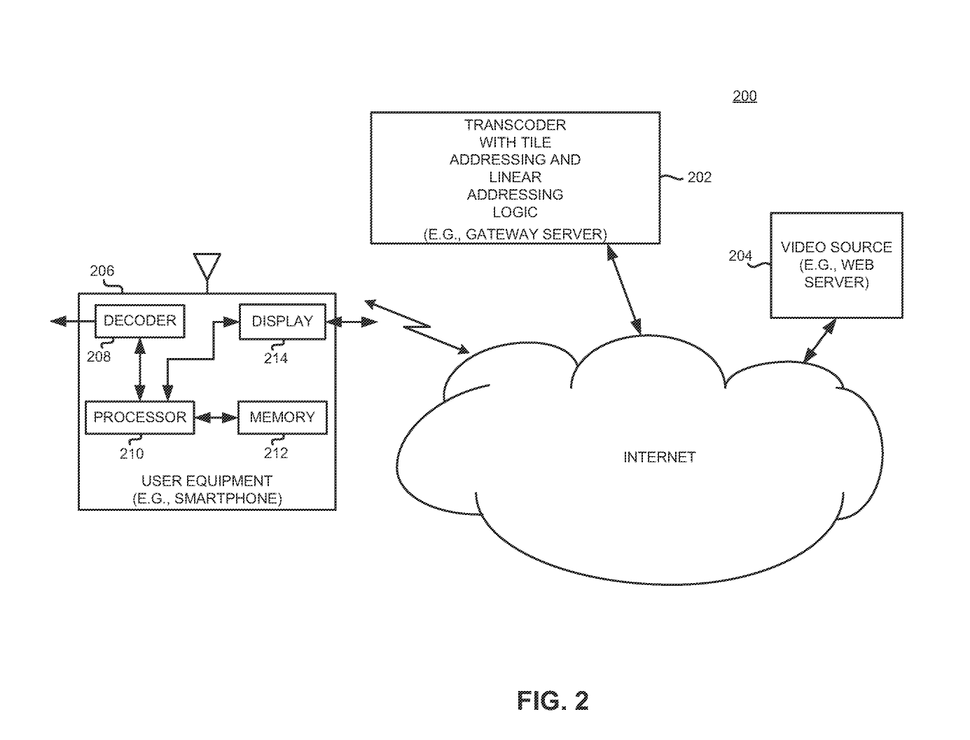

FIG. 2 illustrates one example of a system 200 that in this example includes a transcoder 202 from a first format to a second format that employs tile addressing and/or linear addressing logic. The system may employ a video source 204 and user equipment 206 such as a smart phone, tablet device, or any other suitable device. The video source 204 may be, for example, a web server that provides video based on requests through web browsers or may be any other suitable source (e.g., local or remote via the internet or via any other suitable network). The transcoder 202 may be, for example, a gateway server or any other suitable network element. In another example, the operations of the transcoder 202 may be included in the user equipment 206, the video source 204 or may be located in any other suitable structure.

In this example, the user equipment 206 includes any suitable wireless communication circuitry and includes a decoder 208, a processor 210, associated memory 212 and a display 214. In this example, it is assumed that the user equipment 206 employs a decoder 208 whose decoding format is different from the format of the video data from the video source 204. This may occur, for example, where a video is in a MPEG format but the wireless device or user equipment 206 utilizes a lower resolution video system such that the video data must be transcoded from a first format to a second format. In this example, the transcoder 202 performs the transcoding operation, however as noted above, the transcoding operation may occur in the video source, in the user equipment or in any other suitable device.

Generally, in operation, the transcoder 202 will obtain a decoded data block or tile containing pixel information for multiple display lines and store tile data from the block in a same line of memory. When the re-encoding occurs, the single line of memory is then reformatted back into a data block which is then used by an encoder to re-encode the decoded data in the second format. If no transcoding needs to be performed, then the conventional linear single data line approach may be employed wherein a line of memory contains data for a single display line from multiple decoded data blocks.

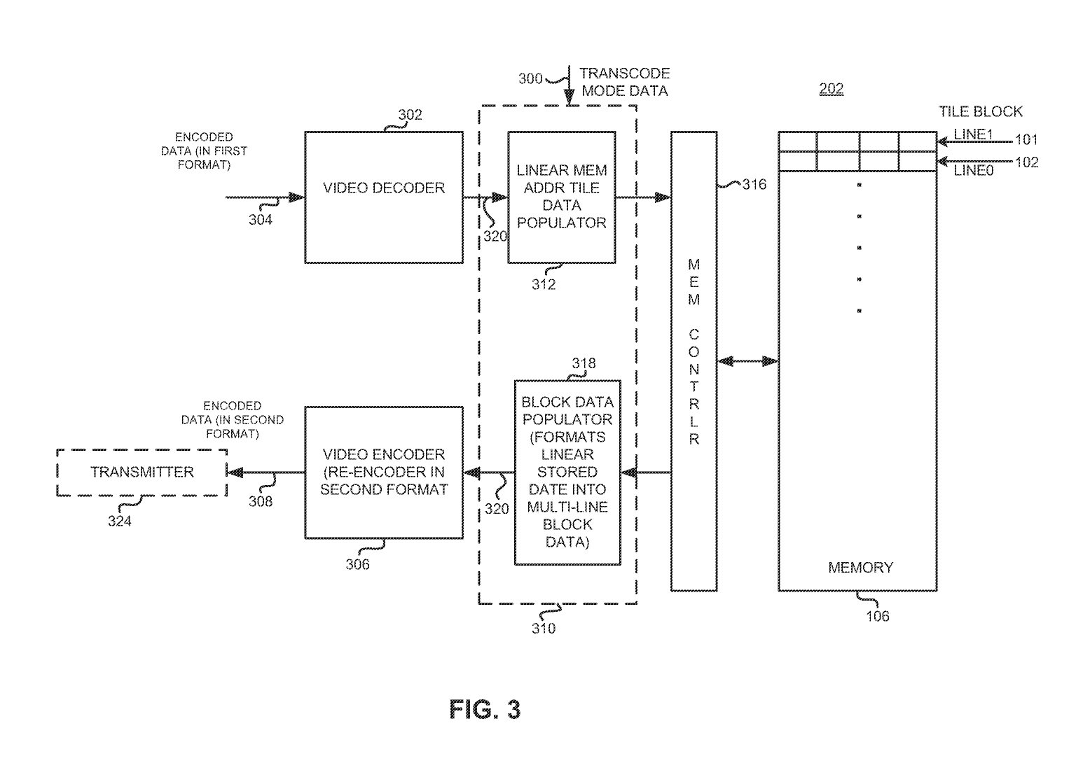

Referring to FIGS. 3-5, one example the transcoder 202 will be described. In this example, the transcoder 202 may include one or more processors that executes code stored in memory and may suitably communicate with the user equipment and video source to determine whether transcoding should be employed using any suitable technique. For example, if the user device wishes to play video then transcoding could be performed. As such, transcode mode data 300 may be provided, for example, by the user equipment from any process. This may be done in any suitable manner such as through a user interface, in a wireless communication or may be a default mode. The transcoder 202 may include a video decoder 302 that obtains the encoded data in the first format shown as 304, for example, from video source 204 or from any other suitable source. A video decoder 306 performs the re-encoding of the encoded data in the second format and produces the encoded data 308 in the second format for communication to the user equipment 206 in this example. A transcoder module 310 includes a linear memory address data block populator 312 coupled to the video decoder and to memory 106 through a memory controller 316 or through any suitable interface. A block data populator 318 reads data from memory 106 and provides decoded data to the video encoder 306 for re-encoding. The transcoder module 310 may be implemented in any suitable manner, such as through a state machine, suitably programmed processor, discrete logic, or any suitable combination of hardware and executing software. The video decoder 302 and video encoder 306 may be conventional video decoders and encoders as known in the art.

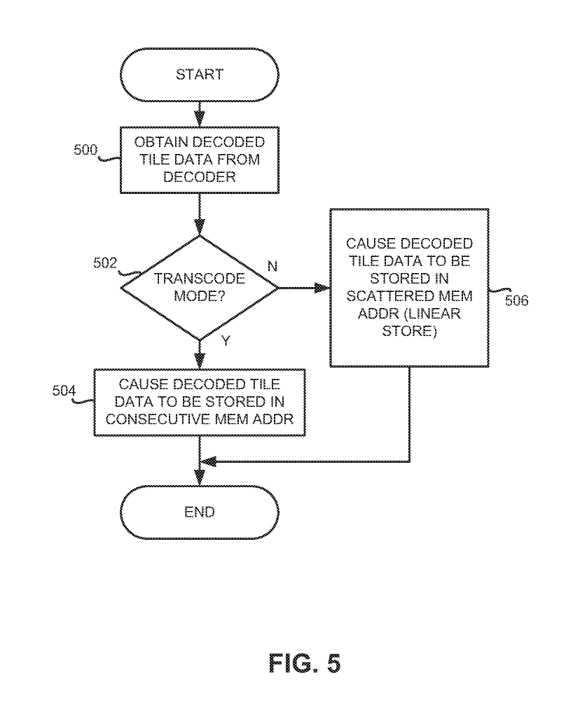

In operation, referring to FIGS. 3 and 5, one example of a method of operation of transcoder module 310 will be described. However, it will be recognized that any suitable structure may carry out the operations and in any suitable order. As shown, the method includes obtaining decoded data block from decoder 302. This is shown as decoded data block 320. This may be performed, for example, by obtaining the information through any suitable bus, register, memory or other known technique that allows the obtaining of a block of decoded video data, for example, to be obtained from the video decoder as it is decoded. As shown in block 502, the method includes determining if a transcode mode has been selected. This may be done, for example, by evaluating transcode mode data 300 if the transcode mode data indicates transcoding is to be performed, then the operation shown in block 504 may occur which includes causing the decoded data block 320 from a block to be stored in consecutive memory addresses in memory 106. This is shown, for example, as the first line of memory being populated with the rows from data block 100. As such, the linear memory address data block populator writes each row of the data block as a linear address in memory. As such, the linear memory address data block populator 312 performs a linear write operation on the decoded data block 320 by controlling storing of the decoded data block in consecutive linear addresses in memory so that a line of memory includes decoded data from multiple display lines from a same block.

This is also illustrated in FIG. 4 where each display line or row of block 100 is stored in consecutive memory addresses as a line of memory 106. If the transcode mode has not been selected, as shown in block 506, the method includes causing the decoded data block to be stored in scattered memory addresses using known techniques such that, for example, rows or lines of pixel information from a single block are stored in non-consecutive memory addresses. The method may continue as desired to perform transcoding operations as necessary.

To re-encode the data in the second format, the transcoder module 310 via the block data populator 318 fetches the line of memory and translates the line of memory back into the decoded data block 320 for re-encoding in a second format. The data block 320 includes data block for multiple display lines.

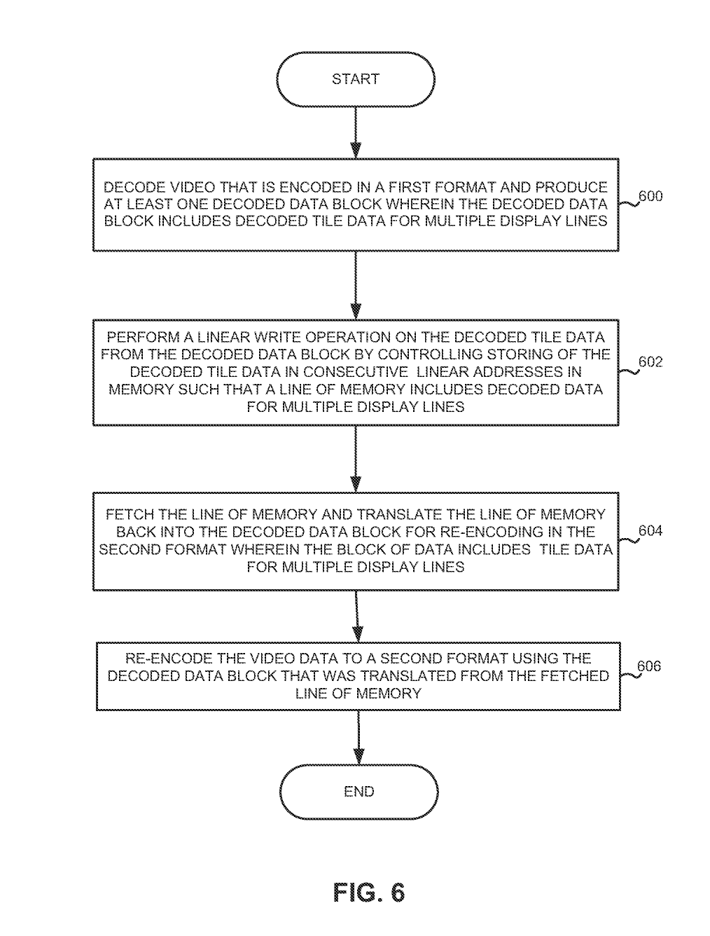

FIG. 6 illustrates another example of a method for transcoding video data from a first format to a second format that may be carried out, for example, by the transcoder 202, or any other suitable structure and in any suitable order. For purposes of illustration, the operations will be described with respect to the elements set forth in FIG. 3. As shown in block 600, the method includes decoding video 304 that is encoded in a first format and producing decoded data blocks wherein a decoded data block may include decoded data block 320 for multiple display lines such as macroblock or any other suitable data block format. This may be done by video decoder 302. As shown in block 602, the method includes performing a linear write operation on the decoded data block 320 by controlling storing of the decoded data block in consecutive linear addresses in memory 106 such that a line of memory includes the decoded data for multiple display lines as shown by line 101. As noted above, these consecutive linear addresses in memory include data from a single block and hence from the 8 different lines shown for block 100 corresponding to display lines. This is done, for example, by the linear memory address data block populator 312.

As shown in block 604, the method includes fetching the line of memory 101 and translating the line of memory back into the decoded data block 320 for re-encoding in a second format wherein the block of data is data block for multiple display lines. This is performed, for example, by the block data populator 318. As shown in block 606, the method includes re-encoding the video data to the second format using the decoded data block that was translated from the fetched line of memory which in this example is performed by the video encoder 306. Populating the memory with the decoded data block in consecutive linear addresses in the memory includes assigning sequential memory addresses to each byte in the decoded data block. [The re-encoded information that is encoded in the second format 308 may then be sent via a suitable transmitter 324 such as a wireless transmitter, wired transmitter or may be further processed as desired. Where the transcoder 202 is employed as part of a multi-media gateway having accessibility to the Internet or other network, the transmitter may be any suitable Internet communication interface. In an alternative embodiment where the transcoder 202 is employed in a wireless network element or in another wireless device, the transmitter 324 may be a wireless transmitter.

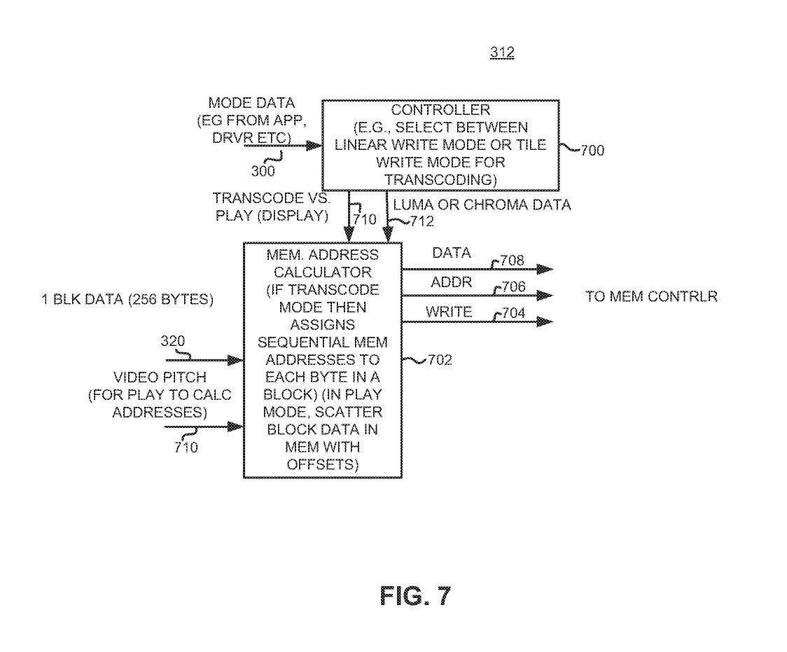

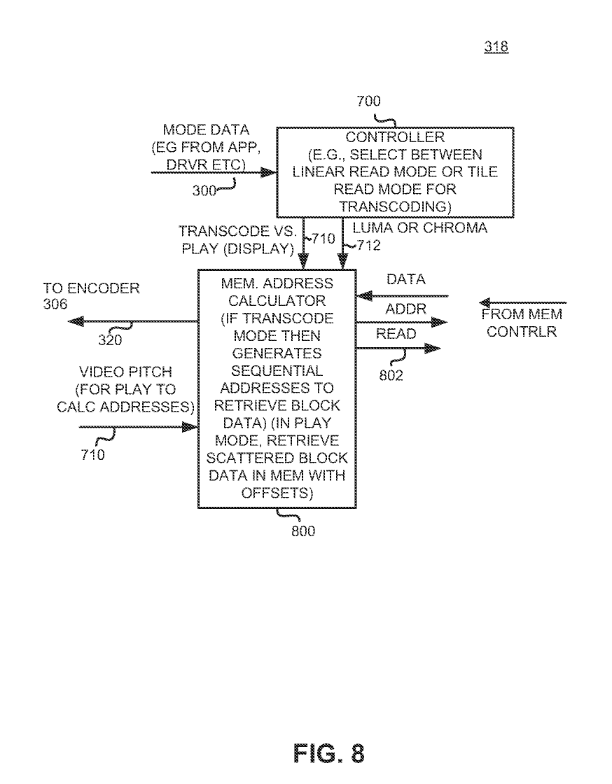

Referring also to FIG. 2, the system may include the user equipment (also referred to as a display device) 206 that includes the decoder 208 that then decodes the re-encoded information in the second format. The processor 210 may further process the video information if desired and provide the video for display on the display 214. It will be recognized however that the transcoder 202 may be employed within the device 206. Further discussion of the transcoder module 310 will be made with reference to FIGS. 7 and 8. FIG. 7 illustrates one example of the linear memory address data block populator 312 and FIG. 8 illustrates an example of the block data populator 318. The memory 106 which is operatively coupled to a linear memory address tile populator 312 and the block data populator 318 stores tile data (the data from the decoded block data) from the video decoder 302 into a linear memory address configuration using consecutive linear addresses for the same block of data.

In this example, a controller 700 determines whether a transcode mode has been selected based, in this example, on mode data 300 which may come from an application, driver, user interface or any other source indicating that transcoding of the encoded data in the first format is to be performed. For example, if the video is to be sent to a device having a different compression codec for example, transcoding may be employed. However, if the device is also able to playback the decoded video that was decoded from the encoded video in the first format, then the decoded data block 320 can be employed for output to a display without any transcoding. As such, the controller 700 controls a memory address calculator 702 that provides write command information 704, address information 706 and data 708 to the memory 106 via memory controller 316. The memory address calculator 702 is controlled through control data 710 either to write the decoded block data 320 in consecutive linear addresses when transcoding, or in scattered memory addresses as in the prior art when no transcoding is necessary. The controller 700 also indicates whether the memory address calculator 702 should be writing luma or chroma data indicated by control data 712. For example, if the controller 700 determines that transcoding is to occur, then the controller 700 selects between a linear write mode (for transcoding) of the decoded data block or a tile write mode (for video playback) based on the mode data 300. The memory address calculator 702 will perform a linear write operation on the decoded data block from the decoded data block 320 into memory 106. In a video playback mode or non-transcode mode, the memory address calculator 702 is controlled to scatter the block data in memory using offsets as known in the art. In one example, as part of transcoding, the linear write operation stores 16×16 luma block data as a set of consecutive linear addresses and stores 8×8 chroma block data as a set of consecutive linear addresses.

Referring to FIG. 8, a memory address calculator 800 is employed under the control of the controller 700 in a similar manner. However, data is read using line fetch read commands 802 to obtain data stored in memory and output the data in a suitable format to the encoder 306. If desired, video pitch information 710 can be employed for playback purposes to calculate which addresses should be written to or read from so that the decoded data can be output for display, also referred to as video pitch information. Video pitch information may be useful where a memory address difference occurs between the start of two consecutive display lines or block data rows due for example to a byte misalignment of stored data. In operation, the controller 700 controls the memory address calculator 800, if in a transcode mode, to generate line fetches to retrieve data from memory and reformat the linear data into tiled data. In a play mode, the memory address calculator 800 retrieves memory from scattered memory locations using offsets that are used by the memory address calculator 700. As such, the controller 700 can select between a linear read mode for transcoding and a tile read mode for video playback (play mode).

Among other advantages, the encoder for re-encoding will obtain the uncompressed data in the same tiled format but based on linear memory addresses reads such that the data is more localized and fewer transactions are required to retrieve the data thereby improving memory use bandwidth.

The disclosed integrated circuit designs may be employed in any suitable apparatus including but not limited to, for example, printers, high definition televisions, handheld devices such as smart phones, tablets, portable devices such as laptops or any other suitable device. Such devices may include for example, a display that is operatively coupled to the integrated circuit where the integrated circuit may be, for example, a GPU, CPU or any other suitable processing circuitry that provides image data for output on one or more displays. Such an apparatus may employ the integrated circuit as noted above including the transcoder 202 and if desired, one or more of the decoder and memory encoder as described as well as any of the one or more described configurations.

Also, integrated circuit design systems (e.g., work stations including, as known in the art, one or more processors, associated memory in communication via one or more buses or other suitable interconnect and other known peripherals) are known that create wafers with integrated circuits based on executable instructions stored on a computer readable medium such as but not limited to CDROM, RAM, other forms of ROM, hard drives, distributed memory, etc. The instructions may be represented by any suitable language such as but not limited to hardware descriptor language (HDL), Verilog or other suitable language. As such, the logic and circuits described herein may also be produced as integrated circuits by such systems using the computer readable medium with instructions stored therein. For example, an integrated circuit with the aforedescribed logic and structure may be created using such integrated circuit fabrication systems. In such a system, the computer readable medium stores instructions executable by one or more integrated circuit design systems that causes the one or more integrated circuit design systems to produce an integrated circuit. The integrated circuit includes logic operative to transcode video data from a first format to a second format comprising decoding video that is encoded in the first format and producing at least one decoded data block that comprises decoded data for multiple display lines, performing a linear write operation on the decoded data block by controlling storing of the decoded data block in consecutive linear addresses in memory such that a line of memory comprises decoded data for multiple display lines, fetching the line of memory and translating the line of memory back into the decoded data block for re-encoding in the second format wherein the block of data comprises data for multiple display lines, and re-encoding the video data to the second format using the decoded data block that was translated from the fetched line of memory and other of the operations set forth herein as desired.

The above detailed description of the invention and the examples described therein have been presented for the purposes of illustration and description only and not by limitation. It is therefore contemplated that the present invention cover any and all modifications, variations or equivalents that fall within the spirit and scope of the basic underlying principles disclosed above and claimed herein.

What is claimed is:

1. A method for transcoding video data from a first format to a second format comprising:
decoding video that is encoded in the first format and producing at least one decoded data block wherein the decoded data block comprises decoded data for multiple display lines;
performing a linear write operation on the decoded data block by controlling storing of the decoded data block in consecutive linear addresses in memory such that a line of memory comprises decoded data for multiple display lines;
fetching the line of memory; and re-encoding in the second format wherein the block of data comprises data for multiple display lines.

2. The method of claim 1 wherein populating memory with the decoded data block by controlling storing of the decoded data block in consecutive linear addresses in the memory comprises assigning sequential memory addresses to each byte in the decoded data block and wherein the method comprises translating the fetched line of memory back into the decoded data block and re-encoding the video data to the second format using the decoded data block that was translated from the fetched line of memory.

3. The method of claim 1 comprising determining whether a transcode mode has been selected and if the transcode mode has not been selected, then causing the decoded data block to be stored in scattered memory addresses in the memory.

4. The method of claim 1 comprising selecting between a linear write mode of the decoded data block and a tile write mode of the decoded data block in memory based on whether transcoding of the video data is to be performed.

5. The method of claim 1 wherein performing the linear write operation on the decoded data block from the decoded data block comprises storing 16×16 luma block data as a set of consecutive linear addresses and storing 8×8 chroma block data as a set of consecutive linear addresses.

6. The method of claim 1 comprising:
sending the re-encoded video of the second format to a display device;
decoding the re-encoded video of the second format and displaying the decoded video.

7. An apparatus for transcoding video data from a first format to a second format comprising:
a video decoder operative to decode video that is encoded in the first format and produce at least one decoded data block that comprises decoded data for multiple display lines;
a linear memory address data block populator, operatively coupled to the video decoder, and operative to perform a linear write operation on the decoded data block by controlling storing of the decoded data block in consecutive linear addresses in memory such that a line of memory comprises decoded data for multiple display lines;
a block data populator operative to fetch the line of memory; and
an encoder, operatively coupled to the block data populator, and operative to re-encode the video data to the second format.

8. The apparatus of claim 7 comprising the memory, operatively coupled to the linear memory address data block populator and to the block data populator, and wherein the linear memory address data block populator populates the memory with the decoded data block by controlling storing of the decoded data block in consecutive linear addresses in the memory by assigning sequential memory addresses to each byte in the decoded data block and wherein the block data populator is operative to translate the fetched line of memory back into the decoded data block and wherein the encoder is operative to re-encode the video data to the second format using the decoded data block that was translated from the fetched line of memory.

9. The apparatus of claim 7 comprising a controller operative to determine whether a transcode mode has been selected and if the transcode mode has not been selected, then causing the decoded data block to be stored in scattered memory addresses in the memory.

10. The apparatus of claim 7 comprising a controller operative to select between a linear write mode of the decoded data block and a tile write mode of the decoded data block in memory based on mode data indicating whether transcoding of the video data is to be performed.

11. The apparatus of claim 7 wherein the linear memory address data block populator is operative to perform the linear write operation on the decoded data block from the decoded data block by storing 16×16 luma block data as a set of consecutive linear addresses and storing 8×8 chroma block data as a set of consecutive linear addresses.

12. The apparatus of claim 7 comprising a transmitter operative to send the re-encoded video of the second format to a display device.

13. A system comprising:
an apparatus for transcoding video data from a first format to a second format comprising:
a video decoder operative to decode video that is encoded in the first format and produce at least one decoded data block that comprises decoded data for multiple display lines;
a linear memory address data block populator, operatively coupled to the video decoder, and operative to perform a linear write operation on the decoded data block by controlling storing of the decoded data block in consecutive linear addresses memory such that a line of memory comprises decoded data for multiple display lines;
a block data populator operative to fetch the line of memory;
an encoder, operatively coupled to the block data populator, and operative to re-encode the video data to the second format from the fetched line of memory;
a transmitter operative to send the re-encoded video of the second format to a display device;
a display device comprising:
a decoder operative to decode the re-encoded video of the second format; and
a display operative to display the decoded video.

14. The system of claim 13 comprising the memory, operatively coupled to the linear memory address data block populator and to the block data populator, and wherein the linear memory address data block populator populates the memory with the decoded data block by controlling storing of the decoded data block in consecutive linear addresses in the memory by assigning sequential memory addresses to each byte in the decoded data block and wherein the block data populator is operative to translate the fetched line of memory back into the decoded data block and wherein the encoder is operative to re-encode the video data to the second format using the decoded data block that was translated from the fetched line of memory.

15. The system of claim 13 comprising a controller operative to determine whether a transcode mode has been selected and if the transcode mode has not been selected, then causing the decoded data block to be stored in scattered memory addresses in the memory.

16. The system of claim 13 comprising a controller operative to select between a linear write mode of the decoded data block and a tile write mode of the decoded data block in memory based on mode data indicating whether transcoding of the video data is to be performed.

17. The system of claim 13 wherein the linear memory address data block populator is operative to perform the linear write operation on the decoded data block from the decoded data block by storing 16×16 luma block data as a set of consecutive linear addresses and storing 8×8 chroma block data as a set of consecutive linear addresses.

18. The system of claim 13 comprising a transmitter operative to send the re-encoded video of the second format to a display device.

19. A non-transitory storage medium that comprises executable instructions that when executed by an integrated circuit fabrication system, causes the integrated circuit fabrication system to produce an integrated circuit that is operative to:
decode video that is encoded in a first format and produce at least one decoded data block that comprises decoded data for multiple display lines;
perform a linear write operation on the decoded data block by controlling storing of the decoded data block in consecutive linear addresses in memory such that a line of memory comprises decoded data for multiple display lines;
fetch the line of memory and translate the line of memory back into the decoded data block for re-encoding in the second format wherein the block of data comprises data block for multiple display lines; and
re-encode the video data to the second format using the decoded data block that was translated from the fetched line of memory.

20. The non-transitory storage medium of claim 1 comprising executable instructions that when executed by the integrated circuit fabrication system, causes the integrated circuit fabrication system to populate memory with the decoded data block by controlling storing of the decoded data block in consecutive linear addresses in the memory by assigning sequential memory addresses to each byte in the decoded data block.
